(19) United States
(12) Patent Application Publication
(10) Pub. No.: US 2015/0191156 A1
(43) Pub. Date: Jul. 9, 2015

(54) SUPPLY CONTAINER, HOLDER FOR A SUPPLY CONTAINER AND VEHICLE TREATMENT FACILITY

(71) Applicant: WashTec Holding GmbH, Augsburg (DE)

(72) Inventor: Franz Kiser, Ried (DE)

(21) Appl. No.: 14/422,535

(22) PCT Filed: Aug. 19, 2013
(86) PCT No.: PCT/EP2013/067230

§ 371 Date: Feb. 19, 2015

(30) Foreign Application Priority Data
Aug. 20, 2012 (DE) 10 2012 107 621.9

(51) Int. Cl. B60S 3/04; B65D 25/20; B65D 85/00; B65D 25/28

(52) U.S. Cl. CPC B60S 3/04; B65D 25/28; B65D 25/20; B65D 85/70

(57) ABSTRACT

A supply container to be inserted in a holder of a metering device in a vehicle treatment facility includes a volume for liquid or viscous additives, and an outlet that can be connected to an inlet of the metering device when inserted into the holder. A holder for such a container includes a metering device inlet that can be sealingly connected to a closeable outlet in the supply container. The supply container can be easily inserted and securely retained in the holder. A supply container on which at least one guiding element is provided for engagement with at least one opposite guiding element on the holder when the supply container is inserted in the holder in a direction of insertion. A holder on which a guide is provided that includes at least one opposite guiding element for guiding at least one guiding element on the supply container when the supply container is inserted in the holder in a direction of insertion. A vehicle treatment facility can be provided with such a holder.

The invention relates to a supply container according to the preamble of claim 1 for insertion into a holder of a vehicle treatment facility, to a holder according to the preamble of claim 16 for such a supply container, and to a vehicle treatment facility according to the preamble of claim 26.

In known vehicle treatment facilities, particularly car washes, various treatment fluids are applied to the vehicles. For example, soil release agents are applied at the start of the cleaning process, which begin to dissolve and soften the dirt present on the vehicle. Then the soil release agents are rinsed off or removed by a high-pressure water jet. The actual washing shampoo is then applied during the subsequent brush wash and again rinsed off with clear water or softened water. Depending on the desired washing program, a wax can then also be applied if desired. These treatment fluids are typically supplied by adding highly-concentrated additives, such as washing shampoos, foaming agents, waxes, drying facilitators, soaps, tire rim cleaners, insect removers, etc., to a base medium, generally water. The generally liquid or viscous additives are usually dispensed into supply containers, which are arranged in holders of a metering device and can be metered using metering pumps into the base medium.

Such a supply container is disclosed in DE 10 2006 022 477 A1 in the form of cartridge designed for insertion into a holding device for a vehicle treatment unit and having an interior for receiving a liquid or viscous medium and an outlet that can be opened for using the cartridge. This cartridge has an inlet, through which liquid or viscous additives can be added to the cartridge. At the bottom of the cartridge, an outlet is provided, which can be connected to an inlet of a metering device in order to be able to feed the additive contained in the cartridge to the metering device. There is the problem in this case that insertion of the cartridge into a cartridge holder is difficult and complicated. The precise positioning of the transponder located on the cartridge in relation to the readout device of the cartridge holder is also difficult.

U.S. Pat. No. 6,158,486 A discloses a supply container holder having a coupling arranged at the inlet of the holder. A snap connection formed thereon by lips holds the container in the holder against the force of a spring. This prevents the container from being pressed out of the holder within a force range defined by the snap connection. If the force range is exceeded, however, the supply container can be easily pulled out of the holder, however; there is no secure locking of the coupling between holder and container.

U.S. Pat. No. 5,651,398 A discloses a dispensing system for chemical fluids, in which a plurality of containers filled with the liquids are placed in a holder. The containers are connected to a metering unit of the dispensing system via hoses. The containers have guiding grooves that extend horizontally and are spaced uniformly apart from one another for introducing the containers into the holder.

US 2003/0141316 A1 discloses a holder for a liquid-filled container that is adapted to the shape of the holder.

U.S. Pat. No. 6,279,836 B1 discloses a dispensing system for liquids in which two liquid-filled containers can be inserted into a holder. For this purpose, horizontally extending guide grooves spaced uniformly apart from one another are provided on the containers, or guide pins are arranged on the holder.

US 2010/0206400 A2 discloses a product dispensing system having a plurality of holders for a plurality of liquid containers, wherein horizontally extending guide rails spaced uniformly apart from one another are provided on the holder.

US 2009/0173753 A1 discloses a cartridge that can be inserted into a holder of a vacuum cleaner. The outer contour of the cartridge is adapted to the shape of the holder.

The invention therefore addresses the problem of creating a supply container for insertion into a holder of a vehicle treatment facility, a holder for such a supply container and a vehicle treatment facility that overcome the above-mentioned disadvantages and enable easy insertion into the holder and secure retention of the supply container in the holder.

The invention solves this problem with a supply container with the features of claim 1 or 14, a holder with the features of claim 16 or 24, and a vehicle treatment facility with the features of claim 27. Advantageous configurations and expedient refinements of the invention are specified in the dependent claims.

A supply container as mentioned above is characterized according to the invention in that at least one guiding element is provided on the supply container, for engaging with a mating guiding element arranged on the holder during insertion of the supply container into the holder in an insertion direction. A correspondingly constructed holder of the type mentioned above is characterized in that a guide is provided on the holder, having at least one mating guiding element for guiding at least one guiding element arranged on the supply container, while the supply container is being inserted in an insertion direction into the holder. In that way, the supply container can be inserted in a simple manner into the holder.

In a preferred embodiment of the invention, the at least one guiding element can run at an angle in the insertion direction toward a center axis of the supply container that extends in the insertion direction and the at least one mating guiding element can correspondingly run at an angle in the insertion direction toward a center axis of the holder extending in the insertion direction. Preferably exactly two guiding elements and two mating guiding elements can be provided, the distance between them decreasing in the insertion direction in a manner matched to one another. Due to these two designs, the supply container can be easily introduced into the holder such that the outlet is aligned with the inlet, so that the two can be easily connected to one another at the end of the insertion.

In an advantageous refinement of the invention, the at least one mating guiding element can be angled downward in the insertion direction toward a bottom of the guide, wherein the at least one guiding element is aligned correspondingly downward.

In order to avoid excessive insertion of the supply container into the holder and thus damage to the supply container and the holder as well as undesired discharge or splashing of the additives, a catch stop is provided, preferably formed from protrusions on the holder and corresponding cutbacks on the supply container.

The at least one guiding element can preferably be arranged on a guiding body formed underneath the bottom of the container interior. The guiding body is not filled with additive and is therefore robustly resistant to the insertion process, so that the supply container can continue to be used even with slight damage to the guiding body. In this case, the guiding body can be shorter, and especially preferably one-third shorter than the catches of the supply container in the insertion direction. In terms of handling, it is further advantageous that the guiding body can be formed on a handle part on a rear end face in the insertion direction, so that the supply container need not be gripped on the walls surrounding the interior and the walls are protected from damage due to the insertion.

In an advantageous refinement of the invention, a data carrier for non-contact transmission of information to and from a readout device of the holder can be mounted on the supply container, wherein a precise positioning of the data carrier relative to the readout device is possible due to the precise guidance of the supply container during insertion. The data carrier can preferably be arranged on the bottom of the guiding body, so that it can be positioned as closely as possible to the readout device arranged in a bottom of the guide.

In another preferred refinement of the invention, a mating coupling piece can be provided in or on the outlet for coupling to a coupling of the holder during insertion of the supply container, and a corresponding coupling for coupling to the mating coupling piece can be provided in or on the inlet. In this way, the insertion and exchange of the supply containers can be designed to be as simple, reliable and danger-free as possible for the user. In an advantageous refinement, a valve that closes automatically when the supply container has not been inserted can be provided alternatively or additionally in or on the outlet, preferably in the mating coupling piece. Preferably, a valve that closes automatically when the supply container has not been inserted can be provided in or on the inlet. Due to the embodiments of the invention just described, the user need not establish and specially check the actual connection between the inlet and the outlet for supplying the additives. When removing a supply container, the user need only unlock the coupling, the valve in the outlet then being automatically closed so that no additive can escape. The valve arranged in or on the inlet can then also automatically close if desired, so that a backflow or splashing of the additive out of the inlet is likewise prevented. Thus a not yet completely emptied supply container can be removed from the holder easily and without danger.

For advantageous use in a vehicle treatment facility, particularly a vehicle washing station, the supply container can be filled with a liquid or viscous (gel-like) additive, particularly a washing shampoo, foaming agent, wax, drying facilitator, soap, tire rim cleaner and/or insect remover.

In addition, the above-mentioned or above-described supply container can be characterized in that the outlet, optionally with the mating coupling piece, is arranged between an end face at the rear in the insertion direction and a front end face of the supply container. The above-mentioned or above-described holder can be characterized in this case in that the inlet is displaced in the direction of an insertion side of the holder at the front in the insertion direction. In a preferred refinement of this embodiment, the outlet can be arranged under a shoulder of the supply container set back from the front side opposite the insertion direction, and the inlet can be shifted forward, opposite the insertion direction, toward the insertion side sufficiently far that a shoulder of the supply container that is set back from the front end face of the supply container opposite the insertion direction comes to rest above the inlet.

In this embodiment, the supply container and the holder can be constructed very compactly and require little space, particularly in the insertion direction. Moreover, the supply container can be inserted into the holder and the supply container can be coupled with the holder in order to supply the additive contained in the supply container simply by inserting the supply container from the front side into the holder, and in the process can be automatically sealingly coupled for dispensing the additive, and the valve or valves in the outlet and/or inlet can be automatically opened without the user having to undertake further steps.

The supply container according to the invention and the holder according to the invention can advantageously be used in a vehicle treatment facility as mentioned above.

A vehicle treatment facility as mentioned above is characterized according to the invention in that a guide is provided on the holder in order to guide the supply container in an insertion direction while the supply container is being introduced into the holder. The vehicle treatment facility is preferably a vehicle cleaning station for washing vehicles with washing brushes and/or high pressure, for applying wax and/or for polishing the vehicle surfaces. The vehicle treatment facility can advantageously be equipped as a portal facility, a drive-through facility or a facility with positive conveyance of the vehicles.

Additional details and advantages of the invention emerge from the following description of a preferred embodiment with reference to the drawings. Therein:

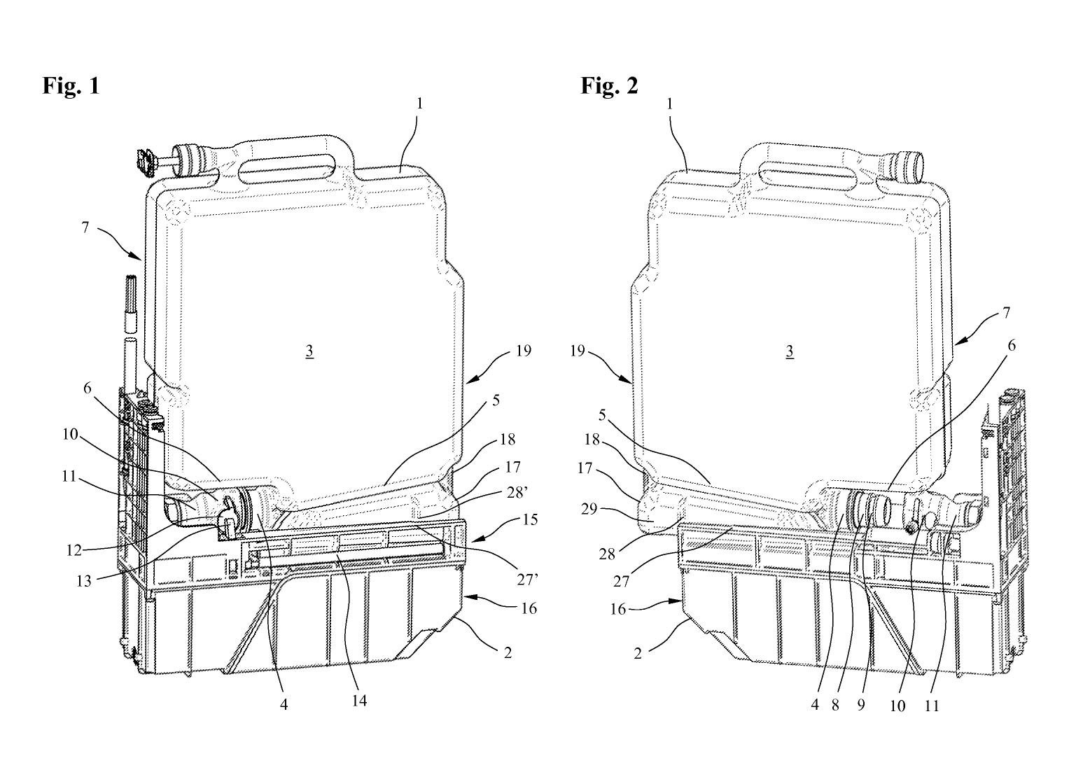

FIG. 1 shows a schematic three-dimensional oblique view of a supply container according to the invention during insertion into a holder according to the invention;

FIG. 2 shows a schematic three-dimensional oblique view of the supply container inserted into the holder from FIG. 1, from a different side;

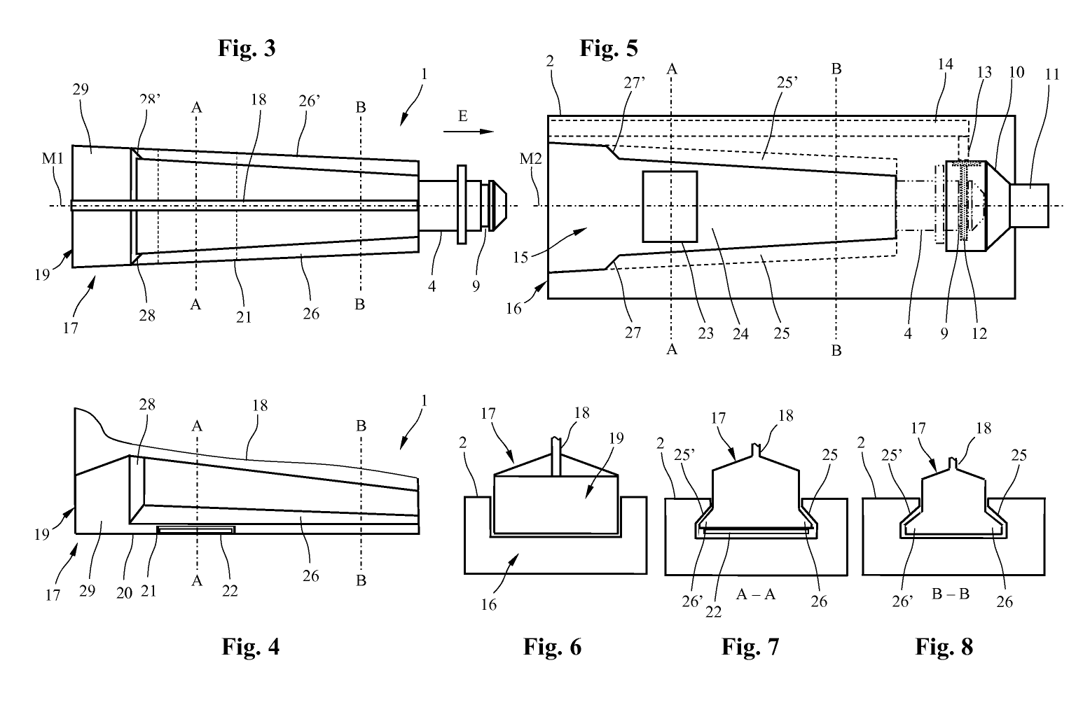

FIG. 3 shows a schematic plan view onto a guiding body of the supply container from FIGS. 1 and 2;

FIG. 4 shows a schematic side view onto the guiding body from FIG. 3 from the bottom in FIG. 3;

FIG. 5 shows a schematic plan view onto a guide of the holder for the guiding body from FIGS. 3 and 4;

FIG. 6 shows a plan view, from the left end face in FIGS. 3-5, onto a guiding body from FIGS. 3 and 4 inserted into the guide from FIG. 5;

FIG. 7 shows a cross section along the section line A-A through the guiding body from FIGS. 3 and 4 inserted into the guide from FIG. 5;

FIG. 8 shows a cross section along the section line B-B through the guiding body from FIGS. 3 and 4 inserted into the guide from FIG. 5.

FIG. 1 shows a schematic three-dimensional oblique view of a supply container 1 according to the invention during insertion in an insertion direction E into a holder 2 according to the invention in a vehicle treatment facility according to the invention, not shown.

The supply container 1 has an interior 3 with a liquid or viscous additive contained therein, such as preferably a washing shampoo, foaming agent, wax, cleaning facilitator, soap, tire rim cleaner and/or insect remover. The supply container 1 is preferably produced from plastic, in particular a hard plastic, consisting, in a favorable embodiment in terms of production, of two half-shells that are fixedly joined to one another and sealingly surround the interior 3.

In order to able to feed the additive contained in the interior 3 to a metering device of the vehicle treatment facility, an outlet 4 is provided at the lower end, as viewed in FIGS. 1 and 2, of the supply container 1. So that even residual amounts of the highly concentrated, sometimes very viscous additive run to the outlet 4 and can be fed to the metering device, a bottom 5 of the interior 3 is inclined toward the outlet 4. The outlet 4 can preferably be arranged under a shoulder 6 of the interior 3, clearly recognizable in FIGS. 1 and 2. The shoulder 6 is set back, opposite the insertion direction E, from an end face 7 of the supply container 1 at the front in the insertion direction E.

The outlet 4 can be sealingly but detachably coupled to an inlet 11 of the metering device via a mating coupling piece 8, provided on the supply container 1 and having an annular groove 9, and an automatically locking coupling 10 provided on the holder 2. When the supply container 1 has been completely inserted into the holder 2 and the coupling 10 has been locked, valves, not shown, provided on the outlet 4 and the inlet 11 for the outflow of the additive contained in the supply container 1 are automatically opened. The valves are preferably provided in the coupling 10 and the mating coupling piece 8. If the supply container 1 is not inserted, at least the valve provided on the outlet 4 is closed.

The coupling 10 preferably holds the supply container 1 automatically in its inserted position and is a spring-actuated snap coupling, for example, which is locked by default. For this purpose, a slider element 12 shown in FIG. 2, which is locked by spring force in the position shown in FIG. 2, is provided on the coupling 10. During insertion of the supply container 1, and thus the mating coupling piece 8, in the insertion direction E, the slider element 12 is briefly pressed to the rear in FIG. 2 until the slider element 12 snaps into the annular groove 9 on the mating coupling piece 8. In this way, the supply container 1 cannot be inadvertently pulled out or fall out of the holder 2, and the user need not remember to lock the coupling 10 after insertion.

In order to open the coupling 10 for removing the supply container 1, a lever 13 is rotated against the slider element 12 by means of a torsion bar 14. The torsion bar 14 is rotatably mounted in the holder 2 and can be rotated, manually or by means of a tool such as a screwdriver, from a front insertion side 16 of the holder 2, which is accessible in the inserted state and is shown on the right in FIG. 1 and on the left in FIG. 2.

For easy insertion of the supply container 1, the holder 2 comprises a guide 16, clearly identifiable in FIGS. 3-8, for a guiding body 17 of the supply container 1. FIGS. 3-8 show a schematic, not exact representation of the parts shown in FIGS. 1 and 2. Thus FIG. 3 shows a plan view onto the guiding body 17, other parts of the supply container 1 being omitted for better comprehensibility.

The guiding body 17 is arranged via a connecting web 18 on the bottom 5 of the interior 3. In a preferred embodiment, the guiding body 17 is integrally formed with the remaining parts of the supply container 1, more particularly the walls surrounding the interior 3. The guiding body 17 can be formed integrally on the half-shells of the supply container 1. The guiding body 17 is not filled with the additive, so that it is sufficiently robust for the guiding function and can be introduced into and removed from the guide 15 often if the supply container 1 is refilled multiple times. If the guiding body 17 is slightly damaged, the supply container can generally continue to be used, because the additive is still located in the interior 3 and does not escape.

As can be clearly recognized in FIGS. 1, 2, 4 and 6-8, the guiding body 17 has a wedge-shaped profile inclined toward the outlet 4, corresponding approximately to the inclination of the bottom 5 of the interior 3. As is additionally recognizable in FIGS. 3 and 6-8, the guiding body 17 also tapers from the wide end face 7, at the front in the insertion direction E, toward the outlet 4, so that the guiding body 17 has a substantially double wedge-like shape toward the outlet 4.

On a substantially flat bottom 20 of the guiding body 17, a recess 21 is formed, on which is provided a transponder 22 or some other type of data carrier that is readable and/or writable by a non-contact method, in order to store information regarding the additive contained in the supply container 1, such as the nature of the additive, metering instructions, age, expiration date, or current fill level of the additive. The transponder 22 is readable and/or writable via a readout device 23, arranged in the holder 2 and indicated in FIG. 5, of the metering device for the vehicle treatment facility, the readout device being preferably connected to a controller of the vehicle treatment facility.

Because the bottom 20 of the guiding body 17 is in contact with the bottom 24 of the guide 15, the recess 21 advantageously serves to protect the transponder 22 during insertion or extraction of the supply container 1, or the guiding body 17, from the guide 15. The recess 21 in the present case extends over the entire width of the bottom 20, but can be smaller or arranged at a different point of the bottom 20.

As is recognizable above all from FIGS. 3 and 5, as well as 6-8, the outer dimensions of the guide 15 and the guiding body 17 are matched for easy insertion of the guiding body 17 into the guide 15. In addition, the guide 15 has mating guiding elements constructed as grooves 25, 25′, with which corresponding shaped guiding elements 26, 26′ of the guiding body 17 engage. As can be seen particularly from the sectional views in FIGS. 6-8, the width of the guiding elements 26, 26′ tapers down toward the outlet 4, while the guiding grooves 25, 25′ narrow accordingly toward the inlet 11. The same applies to the height of the guiding grooves 25, 25′ and the guiding elements 26, 26, which decrease toward the inlet 11 or the outlet 4. In this way, the supply container 1 can be inserted into the holder 1 [sic; 2] easily, yet with a precise fit, so that the mating coupling piece 8 and the coupling 10 can be easily coupled and the valves on the outlet 4 and the inlet 11 can be easily opened at the same time.

In order to prevent an excessive insertion of the supply container 1 into the holder 2 and thus damage to the mating coupling piece 8, the coupling 10 and especially the valves arranged on the outlet 4 and the inlet 11, protrusions 27, 27′ extending substantially vertically upward are arranged on the guide 15, and corresponding cutbacks 28, 28′ are arranged on the guiding body 17, as is clearly recognizable in FIGS. 3-5. The protrusions 27, 27′ and cutbacks 28, 28′ are arranged such that the mating coupling piece 7 can be completely accommodated by the coupling 10 when the supply container 1 is completely inserted into the holder 2, as indicated by the dot-dash lines in FIG. 5.

The cutbacks 28, 28′, and along with them the guiding elements 26, 26′, are offset somewhat toward the outlet 4 from the rear end face 19, in the insertion direction E, of the supply container 1, or of the guiding body 17, so that the guiding body 17 forms a broader handle part 29 on the end face, by which the guiding body 17, and thus the supply container 1, can be more easily gripped and handled. In addition, the guiding elements 26, 26′ offset from the end face 19 toward the outlet 4 are less easily damaged when the guiding body 17 is gripped. The cutbacks 28, 28′, and with them the guiding elements 26, 26′, can also begin at the end face 18, however.

The cutbacks 28, 28′ and the guiding elements 26, 26′ can also be arranged at different points, wherein the cutbacks 28, 28′ can also be shifted in the direction of the outlet 4.

The arrangement of guiding grooves 25, 25′ and guiding elements 26, 26′ respectively on the holder 2 and the supply container 1 can also be interchanged. Other sliding guides can also advantageously be used. Thus longitudinal guiding protrusions having a semicircular cross section can be provided on the supply container 1 and engage with matching guiding grooves having a semicircular cross section, or longitudinal guiding protrusions having a semicircular cross section can be provided on the guide 15 and engage with longitudinal guiding grooves on the supply container 1.

### LIST OF REFERENCE SYMBOLS

1 Supply container
2 Holder
3 Interior
4 Outlet
5 Bottom of interior
6 Shoulder
7 Front end face of supply container
8 Mating coupling piece
9 Annular groove
10 Coupling
11 Inlet
12 Slider element
13 Lever
14 Torsion bar
15 Guide
16 Insertion side of holder
17 Guiding body
18 Connecting web
19 Rear end face of supply container
20 Bottom of guiding body
21 Recess
22 Transponder
23 Readout device
24 Bottom of guide
25, 25′ Guiding grooves
26, 26′ Guiding elements
27, 27′ Protrusion
28, 28′ Cutbacks
29 Handle part

1. Supply container for insertion into a holder of a metering device for a vehicle treatment facility, having an interior for liquid or viscous additives and an outlet that can be connected to an inlet of the metering device upon insertion into the holder, wherein at least one guiding element is provided on the supply container for engaging with at least one mating guiding element arranged on the holder, upon insertion of the supply container into the holder in an insertion direction.

2. Supply container according to claim 1, wherein the at least one guiding element runs at an angle in the insertion direction toward a center axis that extends in the insertion direction of the supply container.

3. Supply container according to claim 1, wherein exactly two guiding elements are provided, the distance between them decreasing in the insertion direction.

4. Supply container according to claim 1, wherein according to one of the preceding claims, characterized in that the at least one guiding element is inclined at an angle downward in the insertion direction.

5. Supply container according to claim 1, wherein a catch stop is arranged thereon.

6. Supply container according to claim 1, wherein the at least one guiding element is arranged on a guiding body formed underneath the bottom of the interior.

7. Supply container according to claim 6, wherein the guiding body is shorter, preferably one-third shorter, than the catches of the supply container in the axial direction.

8. Supply container according to claim 6, wherein the guiding body is formed as a handle part on an end face at the rear in the insertion direction.

9. Supply container according to claim 1, wherein a bottom of the interior is inclined toward the outlet.

10. Supply container according to claim 1, wherein a data carrier for non-contact transmission of information to and from a readout device of the holder is mounted on the supply container.

11. Supply container according to claim 1, a mating coupling piece for coupling to a coupling of the holder is provided at the outlet.

12. Supply container according to claim 1, wherein a valve that closes automatically when the supply container is not inserted is provided at the outlet, preferably in the mating coupling piece.

13. Supply container according to claim 1, wherein it is filled with a liquid or viscous additive, particularly a washing shampoo, foaming agent, wax, drying facilitator, soap, tire rim cleaner and/or insect remover.

14. Supply container according to claim 1, wherein the outlet, optionally with the mating coupling piece, is arranged between an end face at the rear in the insertion direction and a front end face of the supply container.

15. Supply container according to claim 14, wherein the outlet is arranged under a shoulder of the supply container that is set back from the front end face of the supply container opposite the insertion direction.

16. Holder for a supply container for liquid or viscous additives for a metering device in a vehicle treatment facility, the holder having an inlet of the metering device that can be connected to a closable outlet of the supply container wherein a guide having at least one mating guiding element is provided on the holder and is used for guiding at least one guiding element arranged on the supply container in an insertion direction during insertion of the supply container into the holder.

17. Holder according to claim 16, wherein the at least one guiding element runs at an angle in the insertion direction toward a center axis that extends in the insertion direction of the holder.

18. Holder according to claim 16, wherein two mating guiding elements are provided, the distance between them decreasing in the insertion direction.

19. Holder according to claim 16, wherein the at least one mating guiding element is angled downward in the insertion direction toward a bottom of the guide.

20. Holder according to claim 16, wherein a catch stop is arranged thereon.

21. Holder according to claim 16, wherein a readout device is mounted for non-contact transmission of information to and from a data carrier arranged on the supply container.

22. Holder according to claim 16, wherein a coupling is provided on the inlet for coupling to a mating coupling piece of the supply container.

23. Holder according to claim 16, wherein a valve that closes automatically when a supply container is not inserted is provided at the inlet, preferably in the coupling.

24. Holder according to claim 16, wherein the inlet is shifted in the direction of an insertion side of the holder that is at the front in the insertion direction (E).

25. Holder according to claim 24, wherein the inlet is shifted opposite the insertion direction toward the insertion side sufficiently that a shoulder of the supply container that is set back opposite the insertion direction from the front end face of the supply container comes to rest above the inlet.

26. Vehicle treatment facility having a metering device for metering liquid or viscous additives into a base medium, and at least one holder for a supply container filled with the additives, wherein the holder has an inlet that can be sealingly connected to a closable outlet of the supply container, wherein a guide is provided on the holder for guiding the supply container in an insertion direction during insertion of the supply container into the holder.

27. (canceled)
